(19) United States
(12) Patent Application Publication
(10) Pub. No.: US 2009/0163087 A1
(43) Pub. Date: Jun. 25, 2009

(54) STUD CONNECTOR AND RELATED METHODS

(75) Inventors: Thomas M. Sweeney, Cincinnati, OH (US); Carl J. Taylor, Cincinnati, OH (US)

Correspondence Address: WOOD, HERRON & EVANS, LLP, 2700 CAREW TOWER, 441 VINE STREET, CINCINNATI, OH, 45202, US

(73) Assignee: ILSCO CORPORATION, Cincinnati, OH (US)

(21) Appl. No.: 11/962,807

(22) Filed: Dec. 21, 2007

(51) Int. Cl. H01R 11/11

(52) U.S. Cl. 439/798

(57) ABSTRACT

A connector for connecting a transformer stud with at least one conductor includes first and second opposed end faces, with each of the faces respectively including first and second ports configured to receive the stud therethrough. A central bore extends from at least the first port for receiving the stud therein. The connector includes a plurality of channels oriented transverse to the central bore with each of the channels being configured to receive a conductor therein. The central bore may extend from the first port to the second port. The central bore may be configured to selectively receive studs of at least two different sizes. The central bore may be configured to selectively receive studs, for example, having respectively diameters of about ⅝ of an inch and about 1 inch. The central bore may include an extruded toothed surface configured to secure the stud there against.

### FIELD OF THE INVENTION

This invention relates to electrical connectors and, more particularly, to connectors to connect transformer studs to conductors.

### BACKGROUND OF THE INVENTION

Various types of electrical connectors are used for connecting electrical conductors to one another or to the terminals of electrical devices. Conventional connectors receive a conductor within a channel or the like and then receive a screw. The screw is then tightened against the conductor so that it is held in physical contact with the connector.

Some connectors are used with transformers having one or more studs, which provide a high voltage, for example, to a group of homes. Connectors of this type connect the stud to several conductors, each leading to a home. Conventional connectors of this type may include a single port defining a bore that receives the stud, with the bore having a machined surface for threadably securing the stud. Connectors of this type may be available in right-handed and left-handed versions, with each of these versions having a port in a specific orientation of the connector relative to the stud. Accordingly, a user may need to stock an inventory of left-handed and right-handed connectors of this type to adapt to different transformers or environments.

Connectors of the type described above have other limitations. For example, the threadable coupling of the stud within the bore does not compensate for the loss of connectivity caused by oxidation formed on threads of the stud. Hence, conduction of electricity from the stud to the conductors may be detrimentally affected under certain conditions.

Conventional connectors may be susceptible to loosening of the coupling of the connector with the conductors. For example, under certain conditions, a tensile force may be exerted on the conductor, causing loosening of such coupling.

Accordingly, it is desirable to have a connector that addresses at least some of the limitations discussed above with respect to conventional connectors.

### SUMMARY OF THE INVENTION

These and other problems in the prior art have been addressed with this invention. In one embodiment, a connector for connecting a transformer stud with at least one conductor includes first and second opposed end faces, with each of the faces respectively including first and second ports configured to receive the stud therethrough. A central bore extends from at least the first port for receiving the stud therein. The connector includes a plurality of channels oriented transverse to the central bore with each of the channels being configured to receive a conductor therein. The central bore may extend from the first port to the second port. The central bore may be configured to selectively receive studs of at least two different sizes. The central bore may be configured to selectively receive studs, for example, having respectively diameters of about ⅝ of an inch and about 1 inch. The central bore may include an extruded toothed surface configured to secure the stud there against. The central bore may define a central axis such that the extruded toothed surface includes a plurality of teeth oriented generally parallel to the central axis. The extruded toothed surface may be configured to pierce through oxidation formed on the stud. The central bore may include a generally V-shaped surface configured to secure the study there against. At least one threaded channel may be oriented transverse to the central bore and be configured to receive a fastener therein to thereby secure the stud to the connector. The connector may include at least one hole that is configured to receive a street light conductor therein, with the conductor having a size range of about 2 AWG to about 14 AWG. At least one slotted aperture may communicate with one of the plurality of channels and be configured to receive a laterally deflected portion of the conductor therein. The at least one slotted aperture may define a peripheral surface that is configured to engage the deflected portion of the conductor to thereby restrict motion thereof relative to the connector.

In another embodiment, a connector may be configured for connecting a transformer stud with at least one conductor. The connector includes first and second opposed end faces with each of the faces respectively including first and second ports defining a central bore configured to receive the stud therein. A plurality of channels is oriented transverse to the central bore with each of the plurality of channels being configured to receive a conductor therein. At least one slotted aperture communicates with one of the plurality of channels and is configured to receive a laterally deflected portion of the conductor therein.

In another embodiment, a connector is configured for connecting a transformer stud with at least one conductor. The connector includes first and second opposed end faces with each of the faces respectively including first and second ports defining a central bore configured to receive the stud therein. A plurality of extruded teeth is oriented generally parallel to a central axis of the central bore and is configured to secure the stud there against. A plurality of channels is oriented transverse to the central bore with each of the plurality of channels being configured to receive a conductor therein.

In another embodiment, a method of securing a transformer stud to at least one conductor includes extruding a central bore of a connector to define a plurality of teeth therein for receiving and securing the stud. The conductor is secured to the connector within one of a plurality of channels oriented generally transverse to the central bore. The method includes laterally deforming the conductor to force a portion thereof to engage a slot in communication with a channel to thereby secure the conductor to the connector. The method may include defining two ports through the connector for selectively receiving the stud therethrough. The method may additionally or alternatively include engaging the stud against the plurality of teeth to pierce through oxidation formed on the stud. The method may include engaging the connector with the stud such that each of the plurality of teeth is oriented transverse to a plurality of threads on the stud.

### BRIEF DESCRIPTION OF DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of a connector connecting a transformer stud and various conductors in accordance with one embodiment of the invention;

FIG. 2 is a perspective drawing of the connector of FIG.1;

FIG. 3 is a cross-sectional view taken along line 3-3 of FIG. 2;

FIG. 4 is a cross-sectional view taken along line 4-4 of FIG. 2;

FIG. 5 is a cross-sectional view taken along line 5-5 of FIG. 2;

FIG. 6 is an enlarged view of encircled area 6 of FIG. 5 showing a conductor secured within a channel of the connector of FIG.2;

FIG. 7 is a cross-sectional view taken along line 7-7 of FIG. 6;

FIG. 8 is a perspective view similar to FIG. 2 showing the connector thereof without fastening elements;

FIG. 9 is front elevation view of the connector of FIG. 8;

FIG. 10 is a rear elevation view of the connector of FIG. 8;

FIG. 11 is a first end elevation view of the connector of FIG. 8;

FIG. 12 is a second end elevation view of the connector of FIG. 8;

FIG. 13 is a top view of the connector of connector of FIG. 8; and

FIG. 14 is a bottom view of the connector of FIG. 8.

### DETAILED DESCRIPTION OF THE INVENTION

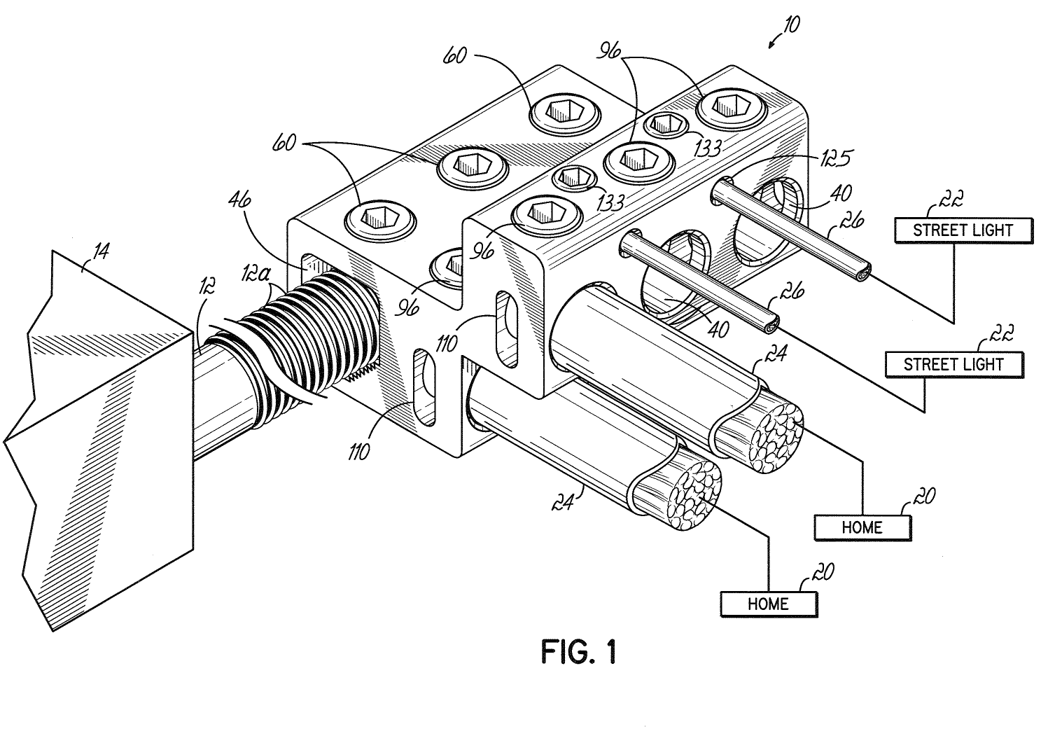

With reference to the drawings and, more particularly to FIG. 1, a connector 10 is depicted connecting a stud 12 of a transformer 14 for conveying electric power to multiple power-consuming devices or systems. The connector 10 may, for example, convey electric power to homes 20 and street lights 22. In this exemplary embodiment, the connector 10 conveys electric power to homes 20 and street lights 22 respectively through conductors 24, 26 coupled to the connector 10.

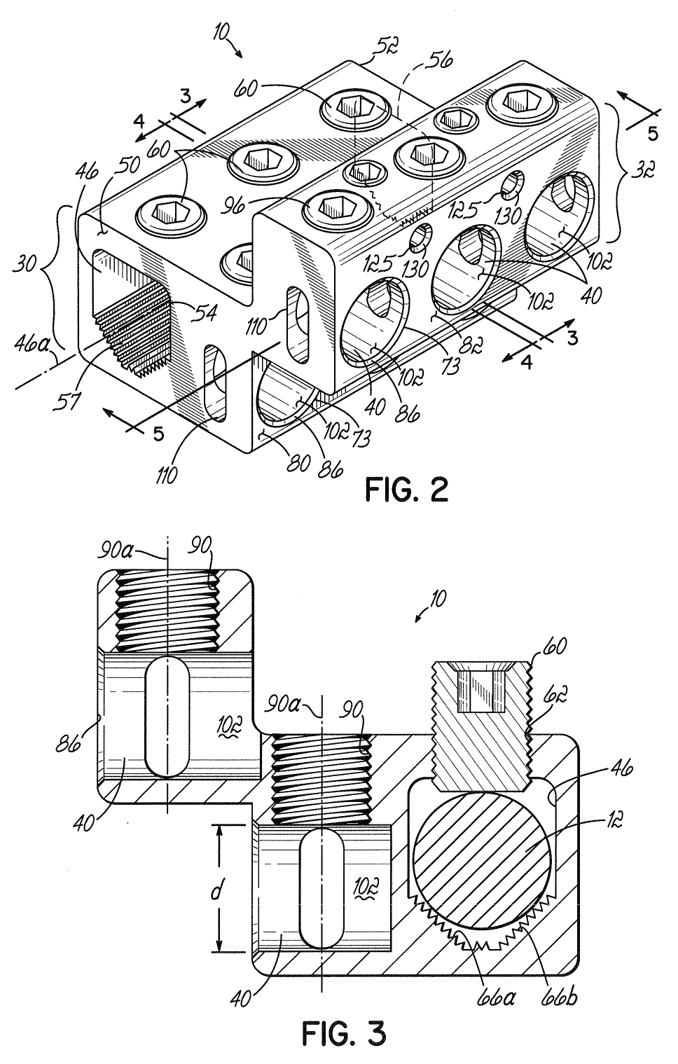

With reference to FIGS. 1-2, the connector 10 in this illustrative embodiment is a generally Z-shaped structure having first and second body portions 30, 32, each of which is configured to connect to at least three conductors 24. To this end, each body portion 30, 32 includes three channels 40, each configured to accept a solid or stranded conductor 24 therein, as explained in further detail below.

Connection to the stud 12 is facilitated by at least one central bore 46 disposed within the first body portion 30 and extending from at least one port of the first body portion 30. In this exemplary embodiment, the first body portion 30 includes opposed end faces 50, 52 each having respective ports 54, 56 configured to selectively accept the stud 12 therethrough and into a single central bore 46 for connection of the connector 10 with the stud 12. In this regard, therefore, the stud 12 may be received into the central bore 46 through either port 54, 56, thereby permitting at least two opposed orientations of the connector 10 relative to the stud 12. Those of ordinary skill will appreciate that, alternatively, the first body portion 30 may include two central bores, each associated with each of the ports 54, 56, such that the connector may be similarly connected to the stud 12 in at least two orientations relative to the stud 12.

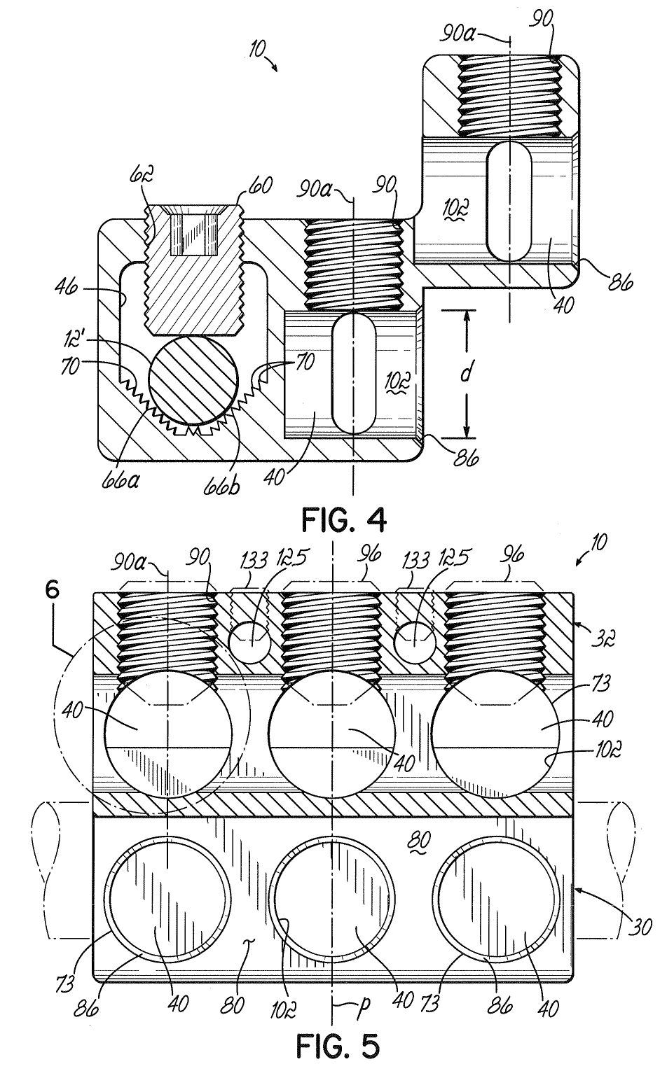

With reference to FIGS. 2-5, the connector 10 is configured to securely hold the stud 12 within the central bore 46, even when such stud is one in a range of different sizes. In this regard, the central bore 46 includes an extruded toothed surface 57 that is configured to securely engage, for example, studs of round cross-sectional shapes and having diameters of about ⅝ of an inch or about 1 inch. The extruded toothed surface 57 is a generally V-shaped surface that cooperates with a fastener such as, for example, a screw 60 received within a transversely oriented threaded channel 62 communicating with the central bore 46 to accommodate studs of various sizes. More particularly, the extruded toothed surface 57 includes opposed, angled V-portions 66a, 66b any point along which may support the stud 12. For example, and with particular reference to FIG. 3, the stud 12 rests upon relatively higher segments of V-portions 66a, 66b and is secured against such segments by screw 60. In contrast, and with particular reference to FIG. 4, a second stud 12′ of a diameter smaller than stud 12 may rest, within the central bore 46, upon relatively lower segments of V-portions 66a, 66b and is also secured in place by screw 60. Although not shown, it is contemplated that the V-shape of the extruded toothed surface 57 may receive and be configured to secure studs having cross-sectional shapes other than round. Likewise, it is contemplated that the shape of the extruded toothed surface 57 may be different from the illustrative V-shape depicted herein, so long as it is capable of accepting and securing a stud within the corresponding central bore. In this embodiment, and with particular reference to FIGS. 3-4, the exemplary connector 10 can be oriented in at least two positions relative to the stud 12, 12′ and further relative to one another. Accordingly, the connector 10 has two orientations that are about 180 degrees from one another. The versatility of orientations is facilitated by the two ports 54, 56 positioned on opposed end faces 50, 52 of the connector 10, both of which are configured to receive the stud 12, 12′ therethrough. Moreover, the connector 10 is symmetrical about a plane “p” (FIG. 5), although this is only illustrative and therefore other non-symmetrical structures are similarly contemplated.

As stated above, the toothed surface 57 is extruded. Accordingly, formation thereof does not require machining within the central bore 46. The shape of the extruded toothed surface 57 is defined by teeth 70 that are oriented along or at least generally parallel to a central axis 46a of the central bore 46. In this regard, and when engaged with threads 12a of the stud 12 (FIG. 1), the teeth 70 apply pressure against the threads 12a to thereby pierce through oxidation disposed on the threads 12a. Accordingly, this type of coupling provides low susceptibility to oxidation deposits formed on the threads 12a, thereby providing a relatively high level of conductivity between the stud 12 and the connector 10.

As discussed above, one or more conductors 24 are coupled to the connector 10 to convey electric power to homes 22 or other power-consuming systems or devices (FIG. 1). To this end, each of the first and second body portions 30, 32 of connector 10 includes channels 40 that are spaced from one another in a direction parallel to the central axis 46a of the central bore 46. Spacing between the channels 40 is suitably chosen to permit human fingers to insert conductors such as stranded conductors through each channel 40 without substantial interference with other conductors that may already be coupled to connector 10. The channels 40 are oriented generally transverse to the central axis 46a to thereby permit connection of several conductors 24 to stud 12 in a relative small space. In this illustrative embodiment, the channels 40 are generally parallel to one another and are further orthogonally oriented relative to the central axis 46a, although this is merely exemplary. The shape, number and size of the channels 40 are suitably chosen to permit coupling with conductors for a specific application. For example, and without limitation, a channel 40 may have a generally round cross-section (best appreciated in FIGS. 2 and 5) and be sized to accept conductors in the range of about 500 MCM to about 10 AWG, although other shapes and/or dimensions are alternatively contemplated. It is also contemplated for a connector to have at least two channels having sizes and/or shapes different from one another and configured to accept conductors in size ranges different from one another.

With continued reference to FIGS. 2-5, each channel 40 is defined by a channel aperture 73 disposed on respective forward faces 80, 82 of the first and second body portions 30, 32, and from which the channels 40 extend. An inwardly oriented lip 86 is disposed about each channel 40 and is adjacent forward faces 80, 82 to facilitate insertion of a conductor 24 through channel aperture 73. All of the channels 40 on the first and second body portions 30, 32 extend from the same side of the connector 10, which facilitates coupling of several conductors 24 with connector 10 without mutual physical interference of conductors 24 with one another. Threaded bores 90 communicate with channels 40 and are oriented transverse thereto for receiving a fastener such as a screw 96. The screw 96 is threadably movable along an axis 90a of each threaded bore 90 such that it can make contact and apply pressure against the conductor 24. In this regard, surfaces 102 defining each channel 40 cooperate with threadable movement of the screw 96 to thereby apply such pressure that secures the conductor 24 within the channel 40.

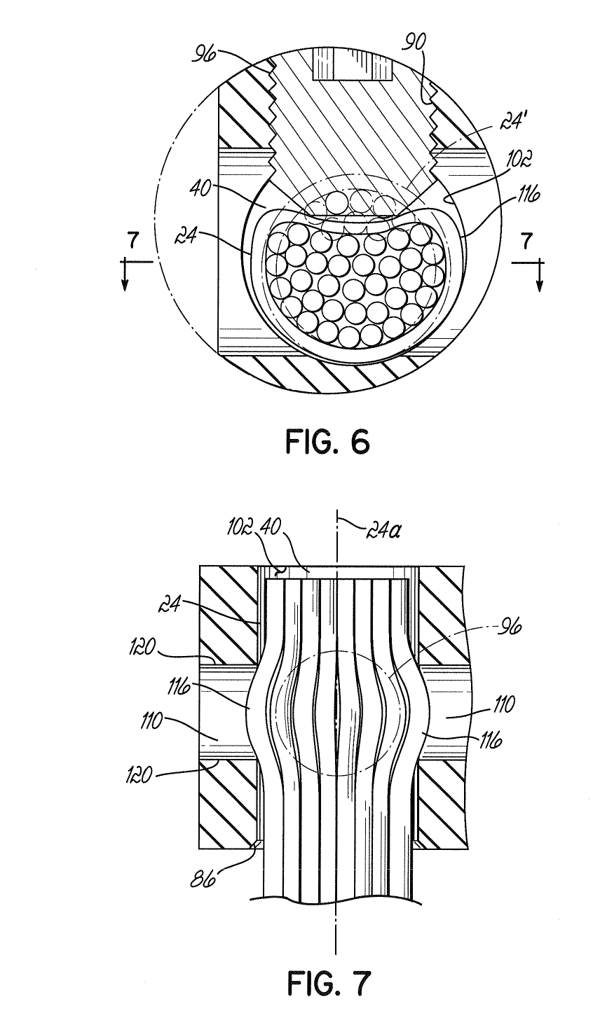

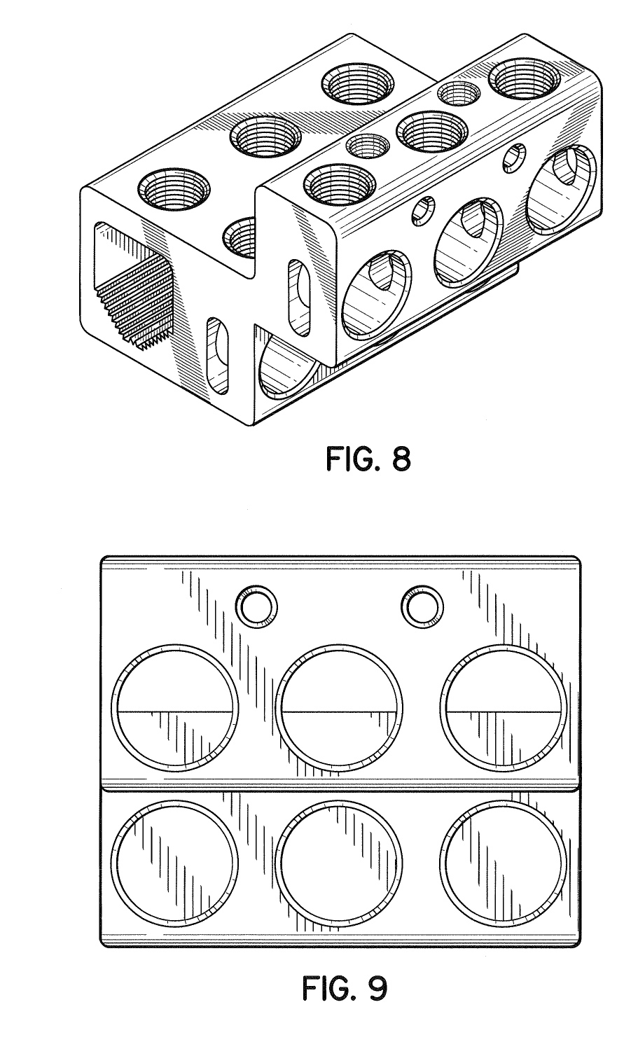

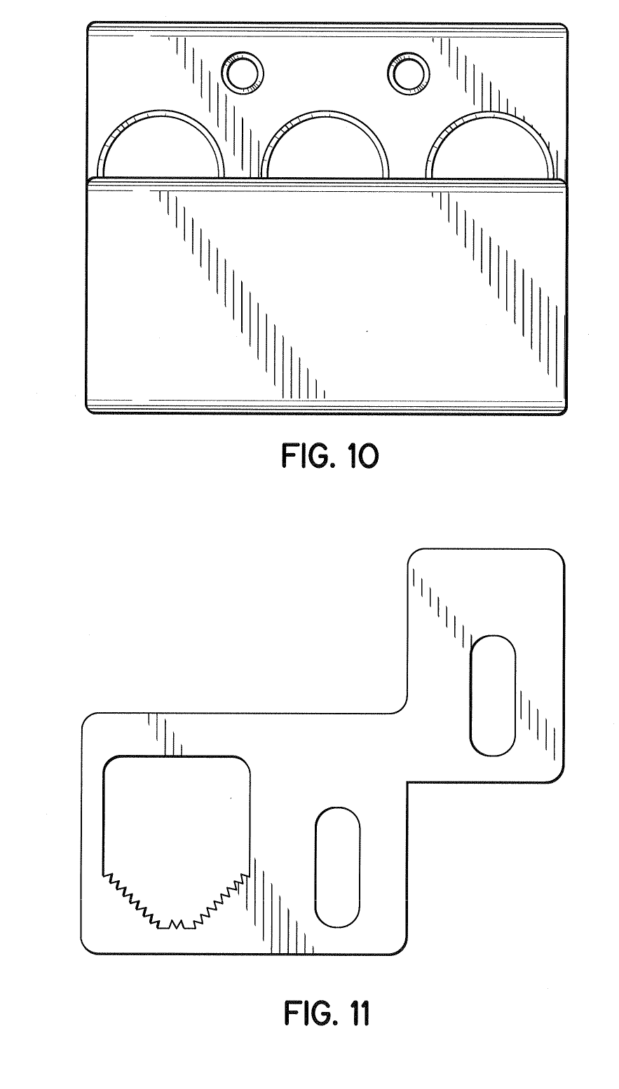

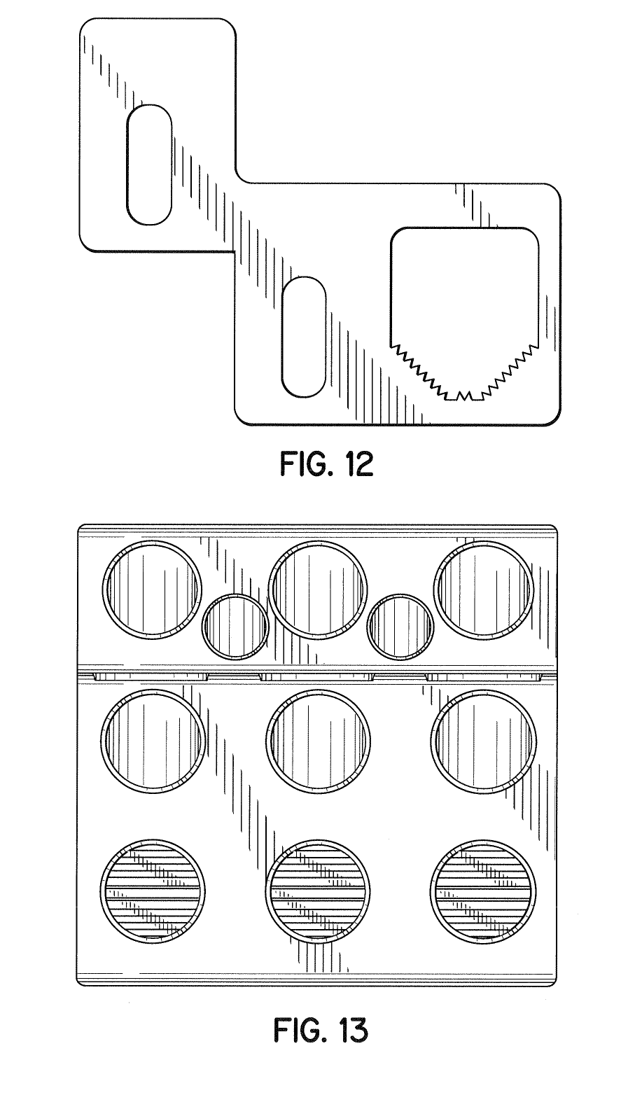

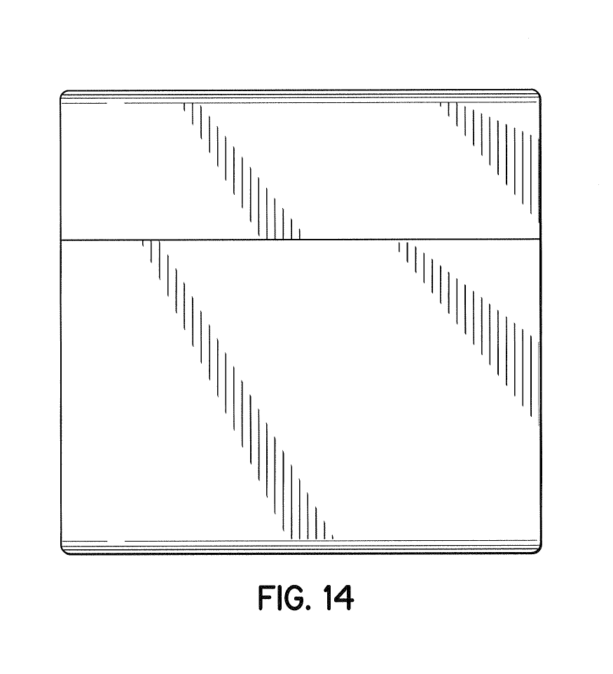

With reference to FIGS. 6-7, the conductor 24 is in the form of a stranded wire although it may alternatively be solid. Slotted apertures 110 cooperate with surfaces 102 and screw 96 to secure the conductor 24 within the channel 40. More particularly, each channel 40 is in communication with at least one slotted aperture 110 being sized, for example and without limitation, to generally match a dimension d of the channel 40 (FIG. 4).

Slotted apertures 110 secure the conductor 24 within the channel 40 by receiving therein a portion of the conductor 24 that is laterally deflected. More particularly, when screw 96 advances toward and engages the conductor 24, the pressure generated against the conductor 24 may deform the conductor 24 from a starting condition 24′, shown in phantom, to a deformed condition, shown in solid lines. The deformed condition may be such that a portion 116 of the conductor 24 deflects laterally. At least some of the deflected portion 116 moves into the slotted aperture 110 and engages peripheral surfaces 120 thereof. When a force exerted on the conductor 24, such as a tensile force along a longitudinal axis 24a thereof, movement of the conductor 24 along the axis 24a and relative to the connector 10 is restricted. While the slotted apertures 110 are depicted having a common oblong shape, other shapes are alternatively contemplated. A connector may, for example, include slotted apertures of different sizes and/or shapes. Examples of such slotted apertures are disclosed in U.S. Pat. No. 6,338,658, the disclosure of which is hereby incorporated in its entirety. Accordingly, connector 10 provides a connection with the conductor 24 that has a relatively low susceptibility to tensile forces exerted on the conductor 24 under certain conditions.

As discussed above, and referring again to FIGS. 1 and 5, the connector 10 conveys electric power from the transformer 14 to systems such as street lights 22. In this exemplary embodiment, the connector 10 conveys electric power to street lights 22 through conductors 26 coupled to the connector 10. More particularly, the connector 10 includes one or more holes 125 extending from the front surface 82 of the second body portion 32 that facilitate such coupling. The holes 125 function in a fashion similar to channels 40 but have a smaller dimension. For example, a hole 125 may be such that it may receive a conductor in the range of about 2 AWG to about 14 AWG, although this is merely illustrative. The holes 125 are configured to receive a fastener such as a screw 133 (shown in phantom) to facilitate locking engagement of a conductor 26. An inwardly oriented lip 130 is disposed about each hole 125 and lies adjacent the front face 82 to facilitate insertion of the conductor 26 through the hole 125. While holes 125 are shown disposed in the second body portion 32 of the connector 10, it is contemplated that they may alternatively be disposed in the first body portion 30 and further in an orientation different from that described above and depicted in FIGS. 2 and 5.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

What is claimed is:

1. A connector for connecting a transformer stud with at least one conductor, comprising:
first and second opposed end faces, each of said first and second faces respectively including first and second ports configured to receive the stud therethrough;
a central bore extending from at least said first port for receiving the stud therein;
wherein said central bore includes a generally V-shaped surface configured to secure the stud there against; and
a plurality of channels oriented transverse to said central bore, each of said plurality of channels configured to receive a conductor therein.

2. The connector of claim 1, wherein said central bore extends from said first port to said second port.

3. The connector of claim 1, wherein said central bore is configured to selectively receive studs of more than two different sizes.

4. The connector of claim 3, wherein said central bore is configured to selectively receive studs having respective diameters of about ⅝ of an inch and about 1 inch.

5. The connector of claim 1, wherein said central bore includes an extruded toothed surface configured to secure the stud there against.

6. A connector for connecting a transformer stud with at least one conductor, comprising:
first and second opposed end faces, each of said first and second faces respectively including first and second ports configured to receive the stud therethrough;
a central bore extending from at least said first port for receiving the stud therein; and
a plurality of channels oriented transverse to said central bore, each of said plurality of channels configured to receive a conductor therein;
wherein said central bore includes an extruded toothed surface configured to secure the stud there against wherein said central bore defines a central axis, said extruded toothed surface including a plurality of teeth oriented generally parallel to said central axis.

7. The connector of claim 6, wherein said extruded toothed surface is configured to pierce through oxidation formed on the stud.

8. (canceled)

9. The connector of claim 1, further comprising:
at least one threaded channel oriented transverse to said central bore and configured to receive a fastener therein to thereby secure the stud to said connector.

10. The connector of claim 1, further comprising:
at least one hole configured to receive a street light conductor therein, the conductor having a size range of about 2 AWG to about 14 AWG.

11. The connector of claim 1, further comprising:
at least one slotted aperture communicating with one of said plurality of channels and configured to receive a laterally deflected portion of the conductor therein.

12. (canceled)

13. The connector of claim 1, wherein said connector is symmetrical about a plane parallel to said first and second opposed end faces.

14. A connector for connecting a transformer stud with at least one conductor, comprising:
first and second opposed end faces, each of said first and second faces respectively including first and second ports defining a central bore configured to receive the stud therein;
a plurality of channels oriented transverse to said central bore, each of said plurality of channels configured to receive a conductor therein; and
wherein said central bore defines a central axis, said central bore including a plurality of extruded teeth oriented generally parallel to said central axis and configured to secure the stud there against.

15. The connector of claim 14 wherein said connector is extruded.

16. The connector of claim 14, wherein said central bore is configured to selectively receive studs of more than two different sizes.

17. The connector of claim 16, wherein said central bore is configured to selectively receive studs having respective diameters of about ⅝ of an inch and about 1 inch.

18. The connector of claim 14, wherein said central bore defines a central axis, said central bore including an extruded toothed surface configured to secure the stud there against.

19. The connector of claim 18, wherein said extruded toothed surface is in the form of a generally V-shaped surface.

20. (canceled)

21. The connector of claim 18, wherein said teeth are configured to pierce through oxidation formed on the stud.

22. The connector of claim 14, wherein said connector is symmetrical about a plane parallel to said first and second opposed end faces.

23. A connector for connecting a transformer stud with at least one conductor, comprising:
first and second opposed end faces, each of said first and second faces respectively including first and second ports defining a central bore configured to receive the stud therein;
a plurality of extruded teeth oriented generally parallel to a central axis of said central bore and configured to secure the stud there against; and
a plurality of channels oriented transverse to said central bore, each of said plurality of channels configured to receive a conductor therein;
wherein said connector is symmetrical about a plane parallel to said first and second opposed end faces.

24. A method of securing a transformer stud to at least one conductor, comprising:
extruding a central bore of a connector to define a plurality of teeth therein for receiving and securing the stud;
securing the conductor to the connector within one of a plurality of channels oriented generally transverse to the central bore;
engaging the stud against the plurality of teeth to pierce through oxidation formed on the stud; and
laterally deforming the conductor to force a portion thereof to engage a slot in communication with the channel, thereby securing the conductor to the connector.

25. The method of claim 24, wherein extruding the central bore includes defining two ports through the connector for selectively receiving the stud therethrough.

26. (canceled)

27. The method of claim 24, further comprising:
engaging the connector with the stud such that each of the plurality of teeth is oriented transverse to a plurality of threads on the stud.

28. The connector of claim 1 wherein the generally V-shaped surface further comprises:
a pair of generally planar portions each extending from the first end face to the second face.

29. The connector of claim 6 wherein each of the plurality of teeth extend from the first end face to the second end face.

30. The connector of claim 14 wherein each of the plurality of teeth extend from the first end face to the second end face.

31. The connector of claim 19 wherein the generally V-shaped surface further comprises:
a pair of generally planar portions each extending from the first end face to the second face.

32. The connector of claim 23 wherein each of the plurality of teeth extend from the first end face to the second end face.
